(19) United States
(12) Patent Application Publication
(10) Pub. No.: US 2003/0039239 A1
(43) Pub. Date: Feb. 27, 2003

(54) Internet protocol telephony dial server

(76) Inventor: Jeffrey D. Ollis, Harleysville, PA (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 09/938,688

(22) Filed: Aug. 24, 2001

(51) Int. Cl. H04L 12/56

(52) U.S. Cl. 370/352; 370/522; 370/401

(57) ABSTRACT

An architecture and method for providing voice over internet telephony with data processing intensive features that would otherwise not be economical to provide to subscribers. A dial server is centrally located and receives audio from a consumer's telephone. The audio signal, which may be voice or dial tones, is processed by the dial server, which associates the information in the audio signal with a telephone number, which is passed to a gateway and thence to a call agent for further routing.

### FIELD OF THE INVENTION

This invention is directed to the field of Internet Protocol telephony.

### BACKGROUND OF THE INVENTION

For well over a century, telephone access has been provided by public switched telephone networks (PSTN, also known as “POTS”), in which each call requires the dedicated use of an individual telephone circuit. As the benefits of computerization have been brought to bear on this system, increasing numbers of features have been made available to the consumer. These include, for example, voice dialing, speed dialing, and other conveniences. Nevertheless, the underlying system still requires the use of dedicated circuits, and thus is inherently limited in the uses to which its potential bandwidth may be put.

The development of the Internet, which makes far more efficient use of available bandwidth by packetizing data streams into data frames and transporting them along dynamically changing routes, has opened up the possibility of providing the consumer both with conventional voice-only telephone services and video telephony at very competitive prices. Typically, these services can be provided over IP networks via Voice-over Internet Protocol (VoIP), the increasingly widespread acceptance of which has facilitated the broad roll-out of IP telephony products and services to the consumer. However, the commercial acceptance of such services depends not only on their cost, but also on their being easy to use and familiar to the consumer.

One service that is increasingly available to the users of PSTN is speed-dialing via voice recognition systems and other memory or processor intensive applications for which the centralization of PSTN provides a suitable level of economy. The commercial acceptance of Internet Protocol network telephony can be advanced by systems that offer similar services at a competitive price-point.

### SUMMARY OF THE INVENTION

The present invention provides architecture and method for providing VoIP customers the ability to use such processor and memory intensive services as the voice recognition dialing of telephone numbers without requiring them to bear the cost of the associated hardware on an individual basis. Instead, these capabilities are localized in a dial server that provides this service for a large number of customers, thereby enabling the cost of the hardware to be distributed over a broad client base at much reduced cost to individual subscribers.

The services of a centrally located dial server are available to telephony gateways connecting a caller to an IP (internet protocol) telephony network (which can be an intranet connected to the Internet). The end user makes use of the gateway to transform his voice into packetized audio, which along with any other information, such as dual-tone multifrequency (DTMF) tones corresponding to any digits entered, are sent to the dial server, which processes this information to yield a telephone number that is then sent to the gateway (also referred to here as a Media Telephony Adapter, or MTA), which in turn sends it to a call agent. The call agent uses this number to further route the call to its destination.

### BRIEF DESCRIPTION OF THE DRAWINGS

FIG. 1 is a block diagram of the logical connections between the elements of this.

FIG. 2 is a sequence diagram of an embodiment of the invention.

### DETAILED DESCRIPTION

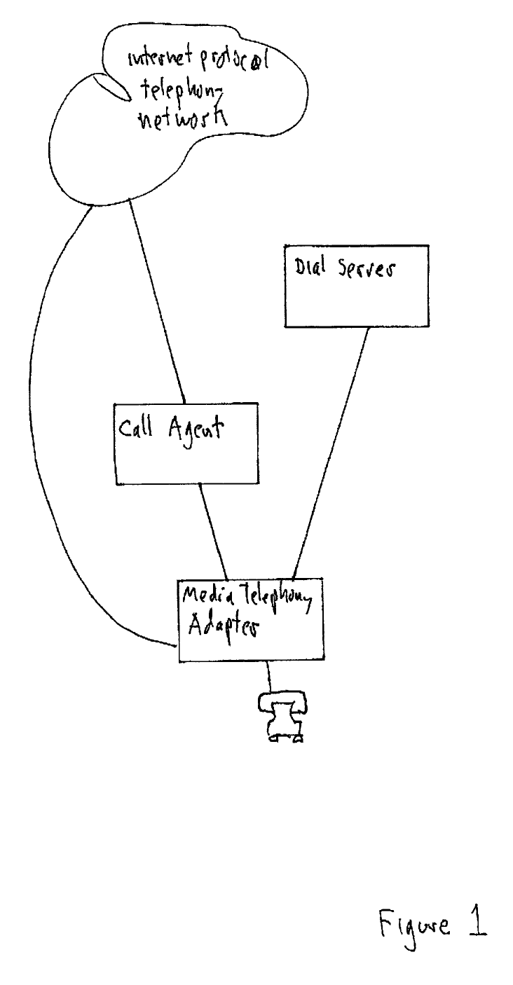

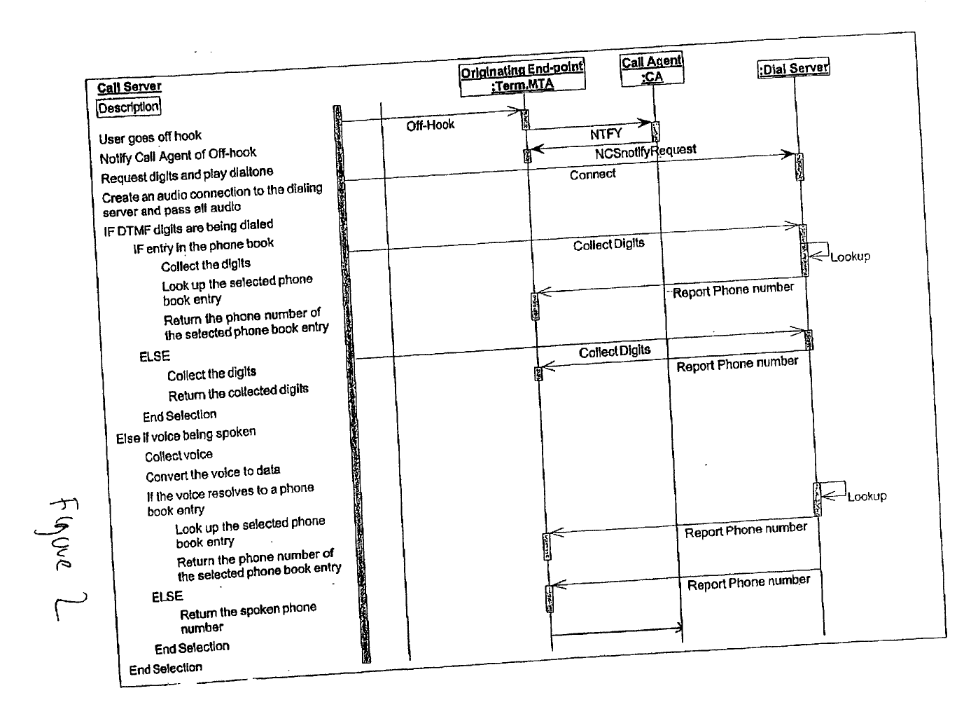

FIG. 1 schematically illustrates the invention. FIG. 2 provides the corresponding sequence diagram. The system utilizes a Call Agent (CA) and a local gateway, herein referred to as a Media Telephony Adapter (MTA). Generally speaking, the Call Agent handles the basic technical aspects of forming a connection. For example, the CA handles call control operations, and has access to data bases that define the location, type, and internet addresses of the end points. The MTA serves as a local gateway, and packetizes the voice traffic into data frames (also known as IP datagrams or datapackets) for transmission over IP network, and thence to a second gateway or telco for reassembly for the benefit of users at the far end of the connection (where both ends utilize VoIP). The MTA also translates incoming data into an analog signal that is conveyed to the user's telephone.

The present invention provides the system with additional capability in a manner that permits the cost to be distributed over a broad client base with minimal expense. When a telephone receiver goes off-hook, the Media Telephony Adapter (MTA) notifies the Call Agent, which instructs the MTA to provide a dial tone and requests digits. In the illustrated embodiment, this request is communicated via NetworkCentricSystem Protocol, which is a variant of the Media Gateway Control Protocol (MGCP). The MTA then creates a pass-through connection from the user to a Dial Server, which contains the processing hardware and software to further analyze the incoming audio signal. If the Dial Server detects dual-tone multifrequency tones (DTMF), then it collects those digits and forwards them to the MTA. The MTA then sends this information to the CA, which attends to the completion of the call over a network connection using VoIP.

Since the centralized Dial Server can be provided with considerably more processing power than could economically be located in the MTA, it can be also be given such voice analyzing capabilities as are needed to permit it to interpret the spoken name of a party, and then look it up in a data base to determine that party's telephone number. The Dial Server then reports the digits of the telephone number to the MTA, which then passes this information to the CA for completion of the call.

In addition to permitting the use of voice dialing, the flexibility of this system permits other applications as well. For example, by providing the data base associated with the DS with the appropriate information, the system can be set up to dynamically select a proper telephone number depending on the time of day or schedule of the called party. Both the CA and the Dial Server can be combined into one device, where warranted. The use of protocols other than VoIP that are suitable for communicating over networks are within the scope of this invention. Also, an interface can be provided to permit this system to synchronize with the data base of a personal digital assistant, company list, mail program, or other data base.

Because the necessary hardware and software is centrally located, these and other services can be provided to the subscriber at minimal additional cost.

What is claimed is:

1. A method for providing enhanced dial-up capabilities to a network connection, comprising the steps of:
establishing an audio connection between a telephone and a dial server;
processing information conveyed by the audio connection to the dial server to obtain a telephone number; and
forwarding that telephone number to a gateway that has a connection to a network.

2. The method of claim 1, wherein the audio connection is formed across the gateway.

3. The method of claim 1, further comprising the step of passing the telephone number from the gateway to a call agent.

4. The method of claim 1, wherein Voice over Internet Protocol is used to communicate with the network.

5. The method of claim 1, wherein the connection to the gateway is established using media gateway control protocol.

6. The method of claim 1, wherein the network is attached to the Internet.

7. The method of claim 1, wherein the network is attached to a PSTN.

8. The method of claim 1, wherein the network is attached both to an internet and to PSTN.

9. The method of claim 1, wherein the audio contains DTMF tones.

10. The method of claim 1, wherein the audio comprises voice, and the Dial Server analyzes the voice to associate it with a telephone number.

11. An apparatus for providing enhanced dial-up capabilities to a network connection, comprising:
a telephone;
a gateway connected to the telephone; and
a dial server connected to the gateway;
wherein the dial server is capable of processing information conveyed by an audio connection with the telephone to obtain a telephone number, which it is capable of forwarding to the gateway.

12. The apparatus of claim 11, wherein the audio connection is formed across the gateway.

13. The apparatus of claim 10, further comprising a call agent to which the telephone number is passed from the gateway.

14. The apparatus of claim 10, wherein the network is attached both to the Internet and to PSTN.

15. The apparatus of claim 10, wherein the network is attached both to an IP network and to PSTN.

16. The apparatus of claim 1, wherein the audio contains DTMF tones.

17. The apparatus of claim 1, wherein the audio comprises voice, and the Dial Server has the ability to analyze the voice so that it can associate it with a telephone number.

18. An apparatus for providing enhanced dial-up capabilities to a network connection, comprising:
a gateway for packetizing audio; and
a dial server connected to the gateway;
wherein the dial server is capable of processing audio information conveyed by an audio connection to a telephone to obtain a telephone number, which the dial server then forwards to the gateway.

19. The apparatus of claim 18, further comprising a call agent for forwarding traffic from the gateway to a network.
